(19) United States
(12) Patent Application Publication
(10) Pub. No.: US 2018/0149179 A1
(43) Pub. Date: May 31, 2018

(54) ELEMENT FOR SECURING A FLAT MOLDED PART

(71) Applicant: ElringKlinger AG, Dettingen-Erms (DE)

(72) Inventors: Michael Schwarzenberger, Dettingen-Erms (DE); Silvio Koch, Dettingen-Erms (DE)

(21) Appl. No.: 15/576,275

(22) PCT Filed: May 16, 2016
(86) PCT No.: PCT/EP2016/060944

§ 371 Date: Nov. 21, 2017

(30) Foreign Application Priority Data
May 22, 2015 (DE) 10 2015 108 150.4

(51) Int. Cl. F16B 5/06

(52) U.S. Cl. CPC F16B 5/0642; F16B 5/0664

(57) ABSTRACT

An element for fastening a flat molded part composed of a thermoplastic material, which is to be positioned on or with at least one other component through a detent-engaging or clamping attachment of the element in at least one flush opening of the molded part and the at least one other component. In order to produce a fastening element, which is attached in captive fashion and can also be detached from a mold or demolded in a non-destructive fashion, it is proposed that the fastening element be integrally and flexibly connected to the molded part by means of a connecting piece.

### FIELD OF THE INVENTION

The present invention relates to an element for fastening a flat molded part composed of a thermoplastic material, which is to be positioned on or with at least one other component, through a detent-engaging or clamping attachment of the element in at least one flush opening of the molded part and the at least one other component.

### BACKGROUND OF THE INVENTION

From the automotive engineering sector and particularly in the engineering of passenger vehicles, numerous solutions are known for fastening flat thermoplastic molded parts—in particular covers and/or mats as molded parts made of silicone rubber—to other components. In addition to glues, these solutions also include screwing, clamping, or riveting as well as the use of clips or plugs. The disadvantages of known solutions include, among other things, the fact that:
with gluing, high cleanliness requirements must be met and allowances must be made for long processing times for curing and a connection of this kind cannot be detached again in a non-destructive fashion;
clamps cannot be released in a non-destructive fashion;
screw attachments are complex and also require a number of components, which are basically not attached in captive fashion;
riveting exhibits a low holding capability due to the small areas of a rivet base and at the same time, the rivet also cannot be detached again in a non-destructive fashion, and
plugs or clips are likewise not attached in captive fashion and also require an additional component; it can also be difficult to achieve a securely fastened assembly.

In one solution approach used in the past, integrated locking components were formed onto the molded part during the initial production of silicone rubber molded parts. This solved the problem of the captive attachment by and large and it also did not require any additional components. But the provision of locking components on a molded part makes it necessary to place limits on the structural embodiment because after the thermoplastic molding process is complete, locking components of this kind can only be removed from a respective mold by means of a forced demolding. In order not to damage the locking components in the process of this, corresponding limits in the design of the locking components must not be exceeded or else a mold becomes unreasonably more expensive, for example because of movable slider elements or the like that is then needed for a removal of the hardened molded part.

### SUMMARY OF THE INVENTION

The object of the present invention, therefore, is to create a fastening element for fastening a molded part composed of a thermoplastic material, which is attached in captive fashion and can also be detached from a mold or demolded in a non-destructive fashion.

This object is attained by the features of the present claim 1 in that an element for attaching a flat molded part, which is composed of a thermoplastic material, to or with at least one other component through a detent-engaging and/or clamping attachment of the element in at least one flush opening in the molded part and in the at least one other component can essentially be fastened by means of nonpositive, frictional engagement, with the fastening element being integrally and flexibly connected to the molded part by means of a connecting piece. The connecting piece thus enables a flexibility for the attachment in the sense of a sufficient mobility of the fastening element up to and extending through the corresponding opening in the molded part. The attachment of a flat molded part to another component—which can be performed in a simple and reliable way, essentially by means of nonpositive, frictional engagement—is an important difference in comparison to a shackle seal or to means for bundling products, as disclosed by U.S. Pat. No. 3,265,426 A, U.S. Pat. No. 5,685,048 A, or WO 2009/043886 A1, among others.

Advantageous modifications of the invention are the subject of the respective dependent claims. Thus, in one embodiment of the invention, the connecting piece is provided in an edge region of the molded part and the connecting piece is dimensioned in its length so that the fastening element can be mounted in the opening of the molded part, namely in an opening that is associated with this respective fastening element.

In a particularly preferable embodiment of the invention, a symmetry axis or symmetry plane of the fastening element is positioned lying in a mold-parting plane of the thermoplastic molded part. In a known manufacturing process, with a fixed attachment of the fastening element to the respective thermoplastic molded part, a positioning of the symmetry axis always lies in an opening direction of a mold. In order to enable a demolding of an injection-molded part from a corresponding mold under these circumstances, it is necessary to correspondingly weaken undercuts or other spreading and/or detent-engaging means, which does in fact reduce problems with the demolding of a finished component, but conversely also significantly reduces an attachment capability of a respective fastening element and thus also, its long-term reliability.

Furthermore, a symmetry plane of the connecting piece preferably lies in a mold-parting plane of the molded part. This achieves a comparatively simple design of a production mold for thermoplastic molded parts, with a fastening element and connecting piece integrally joined thereto. This ensures a broad freedom of design specifically in the region of the fastening element without having to take steps such as forced demolding after completion of a production process or having to take additional structural steps in the mold itself. The foregoing basically also applies to the design of the fastening element.

To produce a particularly advantageous flexibility of the connecting means, it is preferable for the connecting means to be embodied as S-shaped or wave-shaped. It is thus possible to achieve a corresponding material length in the narrowest possible space while avoiding significant tensile or flexural stress in the connecting means during use.

In a particularly preferred embodiment, the fastening element itself is shaped in the form of a plug or clip. In this connection, the person skilled in the art is aware that a plug has at least one detent-engaging or locking means that is embodied in the form of an arm that widens or spreads in or behind an insertion opening, viewed in the insertion direction, or in the form of a correspondingly elastically deformable shoulder with an undercut. Situated opposite from this is a terminal shoulder that is usually connected via a shaft to the detent-engaging or locking means and that comes to an end, for example, at a head part of the plug. Such a device generally has at least one symmetry plane if not being embodied as symmetrical around a central axis.

Preferably, the fastening element is provided with a guide lug in a free end region. This guide lug can be integrally formed as transitioning into detent-engaging or locking means and serves as an insertion and positioning aid for the insertion of an element according to the invention through flush openings of at least two elements, only one of which is the corresponding thermoplastic molded part whose integral component is the fastening element with the connecting piece.

In one exemplary embodiment of the invention, the guide lug is embodied as a section that is cylindrical, conical, or the shape of a truncated cone. Preferably the guide lug has a diameter that is slightly smaller than an inner diameter of the corresponding openings.

In one embodiment of the invention, it is also preferable that in a free end region of the guide lug, the fastening element is longer than a thickness of the molded part and the at least one other component in the region of the flush openings. Consequently, the guide lug positions a correspondingly embodied fastening element on the one hand relative to the openings and is guided through them until the fastening element, by means of the guide lug itself, can be pulled through the openings in a corresponding way against the resistance of the at least one locking and attaching device until a secure attachment is achieved.

In a preferred embodiment of the invention, a recess extending around the opening is provided in the molded part, which recess is adapted to the head part in such a way that when the fastening element is securely detent-engaged in the opening, the head part of the fastening element is positioned in the recess and comes to an end essentially flush with a surface of the molded part. This enables a simple and nevertheless reliable visual inspection of the attachment points for a correct detent engagement.

It is particularly advantageous to produce a molded part together with the connecting piece and to produce at least one fastening element out of a silicone or silicone rubber. In this case, the person skilled in the art is adequately aware of various design options in the context of thermoplastic manufacturing processes. This method is likewise sufficiently known with regard to the mechanical stresses that accompany the assembly and attachment of the fastening elements, but also with regard to thermal influences, environmental influences, and other working conditions in the region of a motor vehicle, particularly in the engine compartment. The materials mentioned above have also sufficiently proven to be usable under thermally challenging environmental conditions, even at ambient temperatures of more than 200° C.

### BRIEF DESCRIPTION OF THE DRAWINGS

Other advantages and advantageous properties of exemplary embodiments according to the invention will be described in greater detail below with reference to the accompanying figures provided in the drawings. In the drawings:

FIG. 1a: schematically depicts a section through basically a side view of a thermoplastic molded part with a fastening element integrally connected to it by means of a connecting piece, showing a mold-parting plane;

FIG. 1b: shows the device according to FIG. 1a, schematically depicting a basic design of a device when installed;

FIGS. 2a to 2c: show a section of a component with a fastening element schematically depicted in three views;

FIG. 3: schematically depicts an installation situation in which a silicone sealing lip is fastened to a metal sheet through the use of another embodiment of a thermoplastic molded part according to the invention;

FIG. 4: shows a schematic, three-dimensional depiction of another embodiment of a molded part according to the invention using three fastening elements to fasten it to a shielding plate;

FIG. 5: schematically depicts a modification of the embodiment from FIG. 1b;

FIG. 6: schematically depicts a modification of the embodiments according to FIGS. 3 and 5; and

FIG. 7: shows a schematic sectional depiction of FIG. 6 as a modification of the embodiments according to FIGS. 1b and 5.

### DETAILED DESCRIPTION OF THE PREFERRED EMBODIMENTS

Components and structural elements that remain the same throughout the different designs and figures are labeled with the same reference numerals below. Without restriction to the application field for embodiments of the present invention, only a use in a motor vehicle will be discussed below. In this case, the attachment of a sealing lip for closing an air gap between an underbody heat shield and an adjoining underbody constitutes one application field for molded parts made of silicone rubber.

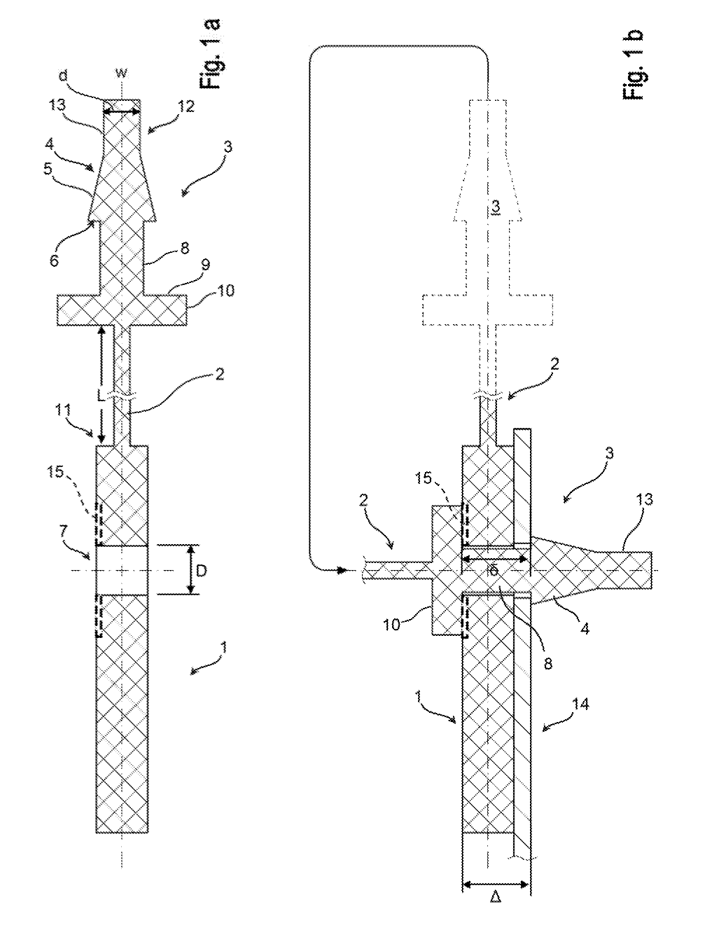

The illustration in FIG. 1a shows a section through a side view of a thermoplastic molded part 1 with a fastening element 3 integrally connected to it by means of a connecting piece 2. In this case, the fastening element 3 is embodied as a so-called plug. As is known, a plug has detent-engaging or locking means 4 in the form of at least one arm or in the present case, a corresponding elastically deformable shoulder 5 with an undercut 6, which can widen and/or spread again in or behind an insertion opening 7. Situated opposite from this is a terminal shoulder 9 that is connected via a shaft 8 to the detent-engaging or locking means 4 and that comes to an end at a head part 10 of the plug 3.

Such a device generally has at least one symmetry plane. In the exemplary embodiment shown, the plug 3 is even embodied as symmetrical around a central axis. By contrast with known manufacturing processes with a fixed attachment of a fastening element to the respective thermoplastic molded part, with a positioning of the symmetry axis that always lies in an opening direction of a mold, in this case, a symmetry plane or even a symmetry axis of the fastening element 3 lies in a mold-parting plane W of the thermoplastic molded part 1 and thus as a rule perpendicular to an opening direction of the mold. According to the prior art, when the finished thermoplastic molded part 1 is removed, a forced demolding of at least the fastening element 3 is required. In adapting to the need for a forced demolding without damaging the component, among other things, undercuts 6 or other spreading and/or detent-engaging means 4 or a deformable shoulder 5 of the fastening element 3 are embodied as correspondingly weakened. Such problems basically do not occur in the present exemplary embodiment due to the shifting of the symmetry plane into the mold-parting plane W. It is thus possible to achieve a maximum attachment capability of the fastening element 3 and thus to also significantly increase its long-term reliability with regard to attaching the molded part 1 as compared to a design known from the prior art.

Based on the mold-parting plane W indicated in this view, it is also clear that a symmetry plane of the connecting piece 2 also lies in the mold-parting plane W. The connecting piece 2 is integrally joined to an edge region 11 of the molded part 1. The view in FIG. 1b shows that depending on a respective application, the fastening element 3 connected to the connecting piece 2 must already be moved a certain distance in order to be fastened in position after having been inserted through the insertion opening 7. The connecting piece 2 must therefore have a sufficient length L with a reasonable degree of inherent rigidity. To achieve this, the relatively narrow connecting means 2 is embodied, for example, as meandering, S-shaped, or wavy in a way that is not indicated here. It is thus possible to achieve a corresponding material length while avoiding a high tensile or flexural stress during use. In addition, the connecting piece 2 is situated so that it extends in the parting plane W, thus taking up only a small amount of space inside an injection mold and can likewise be freely and easily removed from the mold.

Finally, the fastening element 3 is also provided with a guide lug 13 in a free end region. The guide lug 13 is embodied as a cylindrical section with a transition into the truncated cone-shaped detent-engaging or locking means 4. The guide lug 13 thus also has a diameter D that is smaller than an inner diameter D of the opening 7. In addition, the guide lug 13 in the free end region 12 of the fastening element 3 is preferably longer than a thickness Δ of the molded part 1 and of the at least one other component 14 in the region of the flush openings 7. Consequently, the fastening element 3, guided by the guide lug 13, can be inserted through the opening 7 of the molded part and through a flush opening in the other component 14. In order to fasten it, the fastening element 3 can thus be manually pulled by the guide lug 13 and/or simultaneously pushed on the head part 10 of the plug 3.

Finally, the thickness Δ of the molded part 1 and the at least one other component 14 in the region of the flush openings 7 corresponds to a length δ of the shaft 8. Dashed lines merely indicate the possibility of recessing the head part 10 of the plug 3 at least partially into the molded part. To this end, for example a plate-shaped recess 15 can be provided around the insertion opening 7 of the molded part 1 and the head part 10 engages at least partially in this recess. This can save space as needed on the other side of a surface O of the molded part 1. If a recess 15 is provided around the opening 7 for example of the molded part 1 in the manner shown in FIGS. 1a and 1b, then the length δ of the shaft 8 can be reduced.

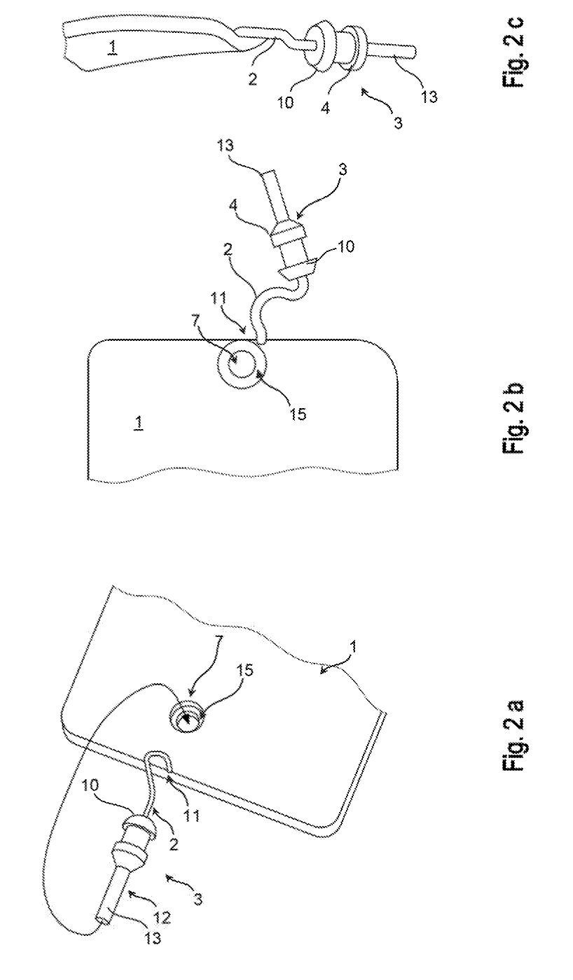

The series of FIGS. 2a to 2c shows three views of a section of a molded part 1 with a fastening element 3 that is integrally joined by means of a connecting piece 2. FIG. 2a shows a three-dimensional view of the molded part 1 with the plug 3 that is integrally joined to the edge region 11 by means of the connecting piece 2. An arrow indicates how the fastening element 3, in this case embodied as a plug, is inserted for installation via the guide lug 13 in its free end region 12 into the opening 7 of the molded part 1 in order to achieve a possibility of a non-destructively detachable, form-fitting connection of a silicone rubber molded part 1 to at least one other arbitrary component. The type and shape of such other components will be further discussed below based on examples from the automotive sector. A special property of this lies in the fact that the detent-engaging and/or locking means 4 that are required for the form-fitting connection are embodied as integral components of the silicone rubber mold 1 and are connected to it in captive fashion in a manufacturing process with only one step. With this in mind, the top view in FIG. 2b clearly shows in this regard that the connecting piece 2 is attached in the edge region 11 of the molded part 1, just above one edge, as is already indicated in FIG. 2a. A required flexibility of the connection of the plug 3 is achieved by means of an S-shape or wavy shape of the relatively thin or narrow and thus easily movable connecting piece 2 in the edge region 11 of the molded part 1. In addition, this approach only exerts a negligible influence on the actual shape of the molded part 1, also only requiring a very small amount of space inside a mold. The accessory to the actual molded part 1, which is composed of the connecting piece 2 and the plug 3 integrally connected thereto, has at least one symmetry plane, which is positioned parallel to an opening direction of a mold in the injection molding process, in fact advantageously in a mold-parting plane. This largely avoids any overcomplication of the production, particularly the need for a forced demolding. Moreover, it is not necessary for the fastening element 3 shown here, which is embodied as a plug, to be rotationally symmetrical; the fastening element 3 can also be equipped in the form of a clip with one or two detent arms serving as detent-engaging and/or locking means 4, provided that it forms a common symmetry plane together with the connecting piece 2.

FIG. 2c illustrates this position once again as a side view. This exemplary embodiment thus also ensures that a symmetry plane that is present in the connecting piece 2 and the fastening element 3 lies in a mold-parting plane w that is not shown in greater detail here, in order to ensure a simple demolding.

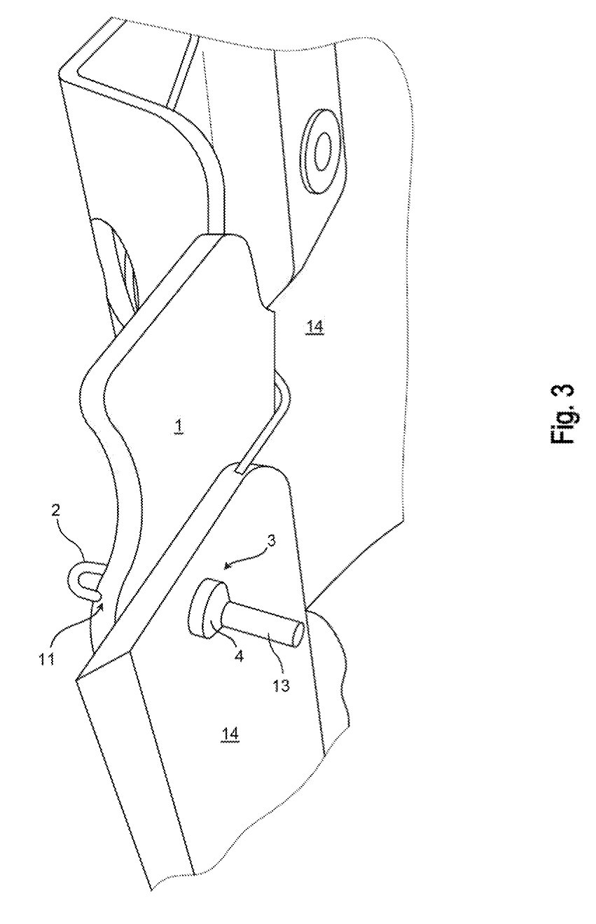

FIG. 3 shows an installation situation in which a silicone sealing lip 14 is pinned to a metal sheet 14. In relation to the embodiment of a molded part 1 shown here, the two elements constitute other components 14 for purposes of the invention. The sealing lip 14 and metal sheet 14 are overlapped using the depicted embodiment of a thermoplastic molded part 1 according to the invention; a fastening by means of a fastening element 3 is particularly embodied as a rattle-preventing element.

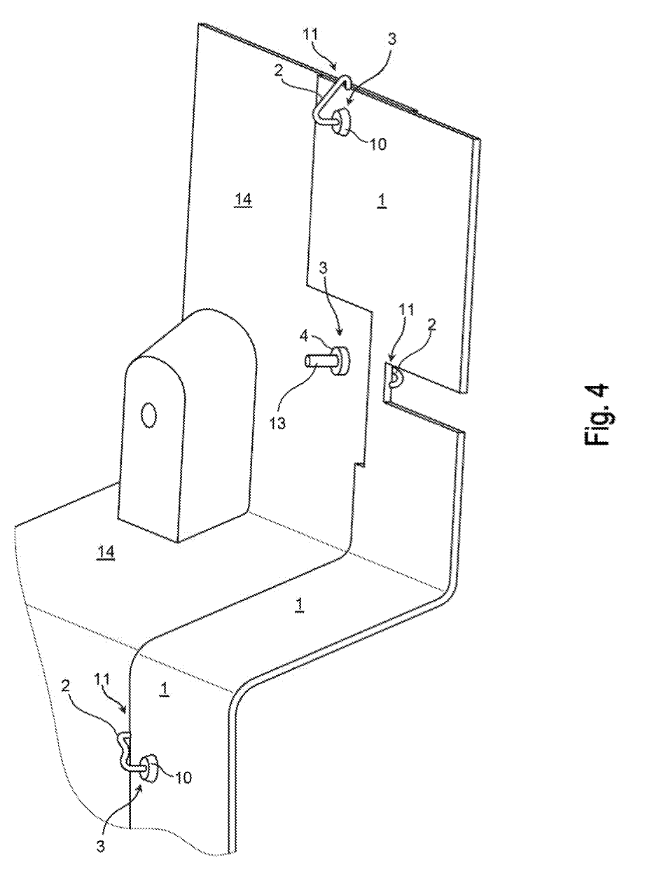

And finally, FIG. 4 is a three-dimensional depiction of another design of a molded part 1 according to the invention. In this application, a molded part 1 is fastened to a shielding plate 14 by means of three fastening elements 3. The fastening elements 3 in this case are fastened in place in both of the basically possible directions by being inserted through openings 7. In this exemplary embodiment, it is clear that not only does a respective connecting piece 2 serve as a flow conduit in a one-step production of an injection-molded part and then serve as a captive attachment and assembly aid. In addition, a curved shape of the connecting pieces 2 when in use is also conspicuous enough that it can serve as a visual inspection element to be checked when visually confirming that the attachment is complete or that the provided fastening points are occupied.

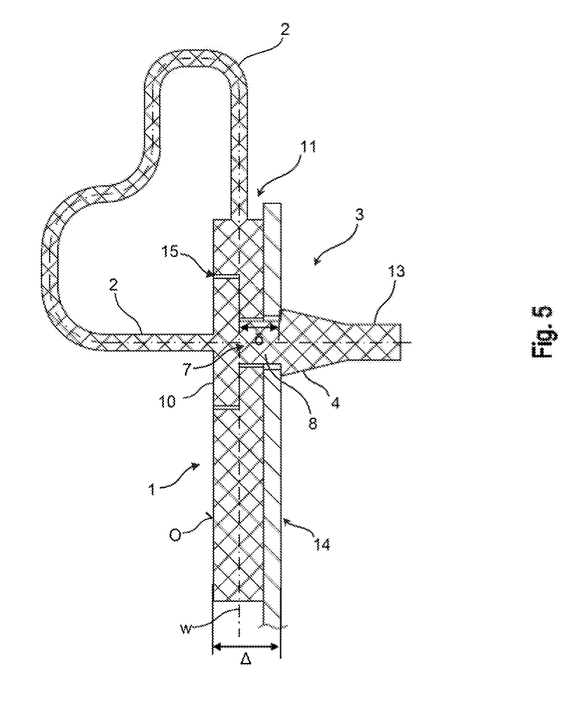

FIG. 5 schematically depicts a modification of the embodiment in FIG. 1b. In this case, the recess 15 provided around the opening 7 has been embodied as extending into the molded part 1 deeply enough that in this case, the head part 10 of the fastening element 3 can be inserted so that it comes to an end flush with a surface O of the molded part 1. In a manner already indicated in the description relating to the depictions in FIGS. 1a and 1b, the recess 15 around the opening 7 of the molded part 1 must not only be correspondingly adapted to an outer shape of the head part 10 of the fastening element 3, the length δ of the shaft 8 must also be correspondingly dimensioned so as to ensure a secure detent engagement of the fastening element 3 in, to, or through the opening 7 of the molded part 1 when the head part 10 is immersed in the recess 15 in flush fashion. A defined “immersion” of the head part 10 of the fastening element 3 in the recess 15 around the opening 7 makes it possible through a quick and easy visual inspection to verify that the fastening in place of the fastening element 3 has been correctly completed.

When, in a modification in an exemplary embodiment of the invention that is not shown in detail in the drawings, several fastening elements 3 are provided close to one another, respectively associated openings 7 of the molded part 1 can also be coded, so to speak, through the cooperation of the head part 10 and recess 15 in that for example the recesses 15, which each have head parts 10 matched to them in fitted pair, have different diameters and/or different outer forms. Thus, in addition to circles, they can also be embodied as ovals, triangles, squares, and polygons as well as other geometric shapes having at least one symmetry plane. It is then also possible to visually associate them quickly and unambiguously when this association cannot be determined by the position and length of the respective connecting pieces 2 and/or when a rotation prevention or similar additional properties are wanted.

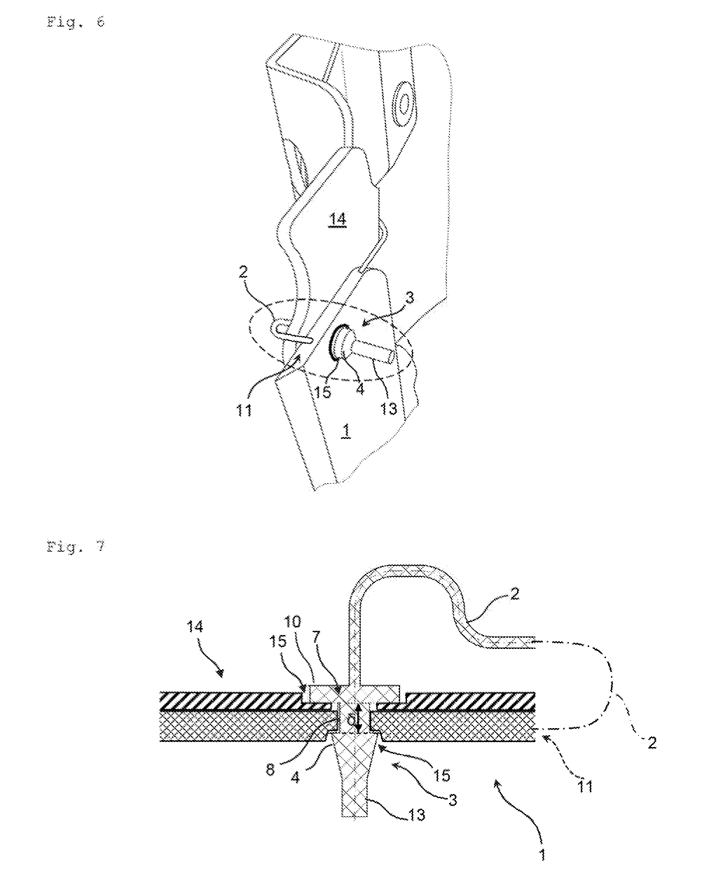

FIG. 6 shows a dual case in comparison to the embodiment from FIG. 3. In this instance, the molded part 1 and the at least one other component 14 have in a certain sense changed places. To accomplish this, the fastening element 3 is first inserted through a no longer visible opening in the component 14 in order to then lock in position with its detent-engaging means 4 in a plate-shaped recess 15 of the molded part 1.

And finally, FIG. 7 schematically depicts a modification of the embodiments according to FIGS. 1b and 5, in this instance depicting a section through a device according to FIG. 6. A head part 10 of the fastening element 3 now in turn engages in a plate-shaped recess 15 and the detent-engaging means 4 is affixed in a plate-shaped recess 15. In this instance, though, in order to achieve the contact of the head part 10, the plate-shaped recess 15 is provided in the other component 14, whereas the plate-shaped recess 15 for affixing the detent-engaging means 4 of the head part 10 of the fastening element 3 is now provided in the molded part 1. The flat elements 1 and 14 are also attached to each other with nonpositive, frictional engagement by means of a tensile stress in the shaft 8.

In all, embodiments of the present invention are thus able to achieve the following advantages:
no additional components required for the connection;
the connection can be non-destructively detached as often as desired;
an assembly after servicing can also be carried out simply and manually, basically without tools;
a forced demolding from a mold during production is not required, which among other things, makes it possible to achieve a significant reduction of the mold costs and an increase in a detent-engaging and/or locking ability of the fastening element 3;
is easily possible to perform a quick and easy visual inspection of the complete occupation of all of the fastening points on a molded part 1 and/or of a correct attachment of the respective fastening elements in the associated openings.

As is readily apparent to the person skilled in the art, a device according to the invention can be used outside of the automotive sector at any time, for example, as a closing or sealing element, particularly on flat and three-dimensionally shaped molded parts or foil parts of any shape. There is basically also nothing to prevent other at least semi-plastic materials such as PVC, PP, PA, or PE from being used in other application fields.

1. A fastening system, comprising:
a fastening element for fastening a flat molded part composed of a thermoplastic material to or with at least one other component through a detent-engaging or clamping attachment of the fastening element in at least one flush opening of the molded part and the at least one other component, wherein the fastening element is integrally and flexibly connected to the molded part by a connecting piece.

2. The fastening system according to claim 1, wherein the connecting piece is provided in an edge region of the molded part and the connecting piece is dimensioned in its length so that the fastening element can be mounted in the opening.

3. The fastening system according to claim 1, wherein a symmetry axis or symmetry plane of the fastening element lies in a mold-parting plane of the molded part.

4. The fastening system according to claim 1, wherein a symmetry plane of the connecting piece lies in a mold-parting plane of the molded part.

5. The fastening system according to claim 1, wherein the connecting piece is S-shaped or wave-shaped.

6. The fastening system according to claim 1, wherein the fastening element is embodied in the form of a plug.

7. The fastening system according to claim 1, wherein the fastening element has a guide lug in a free end region.

8. The fastening system according to claim 7, wherein the guide lug is embodied as a section that is cylindrical, conical, or the shape of a truncated cone and has a diameter that is slightly smaller than an inner diameter of the opening, and/or
is longer than a thickness of the molded part and the at least one other component in the region of the flush opening.

9. The fastening system according to claim 1, further comprising a recess extending around the opening in the molded part, which is adapted to a head part of the fastening element in such a way that when the fastening element is securely detent-engaged in the opening, the head part of the fastening element is positioned in the recess and comes to an end essentially flush with a surface of the molded part.

10. The fastening system according to claim 1, wherein the molded part, the connecting piece, and the fastening element are composed of a silicone or silicone rubber.
